(19) United States
(12) Patent Application Publication
(10) Pub. No.: US 2003/0149746 A1
(43) Pub. Date: Aug. 7, 2003

(54) Ensobox: an internet services provider appliance that enables an operator thereof to offer a full range of internet services

(75) Inventors: David A. Baldwin, Rockville, MD (US); Syed S. Towheed, Herndon, VA (US)

Correspondence Address: Ensoport Internetworks, 2401 Pennsylvania Ave NW 300, Washington, DC, 20037, US

(73) Assignee: Ensoport Internetworks, Washington, DC

(21) Appl. No.: 09/976,058

(22) Filed: Oct. 15, 2001

(51) Int. Cl. G06F 15/16

(52) U.S. Cl. 709/219

(57) ABSTRACT

The ensoBox™ is an Internet Service Provider (ISP) appliance. An Internet appliance can be classified as a ready-to-use device that supports a specific Internet requirement. The software to support this appliance is pre-installed in the factory, is typically proprietary in nature, and is purchased in conjunction with the associated hardware. An appliance supports a plug-and-play configuration to allow for easy installation and management by the appliance's owner. An Internet appliance does not require the separate purchase of hardware and software, and then the subsequent systems integration by the owner.

An ISP appliance provides the functionality of an ISP into a device or cluster of devices where hardware and software are integrated in such a manner that the owner of the ISP appliance can be a fully functional, fully independent, self-supported ISP. An ISP appliance, at a minimum, should support basic ISP functions described in above specification.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Technical Field of Invention

The ensoBox™ is an ISP appliance technology that enables the complete technology required for an Internet Service Provider (ISP). Currently, in the build out of an ISP operation it is necessary to build requirements, analyze, design, implement, test and roll out equipment and software into a production environment. This ISP appliance technology is completely turnkey and as a result can be deployed without the standard software/hardware life-cycle. This technology provides everything that an ISP needs to begin operating an ISP business within 90 days. Simply put, ISPs now have the ability to plug in telco, power, backbone, and flip a switch and they can start operating a successful ISP business.

There are some terms and definitions required in order to understand the technical aspects of this design. They are as follows:

Terms and Definitions

AAA—Authentication, Authorization, Accounting.

Analog Service—Plain Old Telephone Service (POTS).

APOP—Authenticated Post Office Protocol.

Appliance—integration of hardware and software into a single platform that offers a specific functionality. An appliance is typically configured with a proprietary operating system.

BRI—Basic Rate Interface.

CFEP—Core Front End Processor.

CHAP—Challenge Handshake Authentication Protocol.

CIDR—Classless Inter Domain Routing.

CLI—Command Line Interface.

COTS—Commercial Off The Shelf.

CSA—Clustered Services Architecture.

DHCP—Dynamic Host Configuration Protocol.

DIMM—Dual In-line Memory Module.

DNS—Domain Name Service.

DRAM—Dynamic Random Access Memory.

E-1 Service—provides digital transmission rates of 2.048 Mbps. It consists of 30 64 Kbps data channels and 2 64 Kbps control channels.

ensoBox™—an ISP appliance that offers direct connectivity to the Internet, dial-up connectivity to the Internet, and a suite of end user services including a web portal, email, chat, news, video conferencing, and anonymous FTP.

ensoOS™—the backend software infrastructure for the ensoBox™. A suite of management tools used by both ensoport.com™ headquarters and franchises for managing ensoBox™ franchises and ensoBox™ subscriber accounts.

ESMTP—Encrypted Simple Mail Transfer Protocol.

FEP—Front End Processor.

Flash Memory—used to store operating system images such as Cisco's IOS.

FT-1—Fractional T-1 Service. N×64 Kbps, where N=1 to 24.

FTP—File Transfer Protocol.

H.323—the name given to a set of communications protocols used by programs such as Microsoft NetMeeting to transmit audio and video information over the Internet.

HTML—Hyper Text Markup Language.

HTTP—Hyper Text Transfer Protocol.

HTTPS—Hyper Text Transfer Protocol Secure.

IMAP—Internet Message Access Protocol.

IRCD—Internet Relay Chat Daemon.

ISDN—Integrated Services Digital Network.

ISP—Internet Services Provider.

ISP Franchise—an entity that utilizes the ensoBox™ ISP appliance to support an ISP business ISP in any region of the world.

LAN—Local Area Network.

LDAP—Lightweight Directory Access Protocol.

NAS—Network Attached Server.

NNTP—Network News Transfer Protocol.

NOC—Network Operations Center.

NTP—Network Time Protocol.

PAP—Password Authentication Protocol.

POP3—Post Office Protocol 3.

POTS—Plain Old Telephone Service.

PPP—Point-to-Point Protocol.

PRI—ISDN Primary Rate Interface. It consists of twenty-three (23) 64 Kbps data channels and one (1) 64 Kbps control channel.

PSTN—Public Switched Telephone Network.

RADIUS—Remote Authentication Dial-In User Service.

RAS—Remote Access Server.

SFEP—Services Front End Processor.

SIMM—Single In-line Memory Module.

SLIP—Serial Line Interface Protocol.

SMTP—Simple Mail Transfer Protocol.

SNMP—Simple Network Management Protocol.

SRAM—Static Random Access Memory.

SSL—Secure Socket Layer.

Subscriber—an ensoport.com™ franchise customer (remote end user).

T-1 Service—provides digital transmission rates of 1.544 Mbps. It consists of twenty-four (24) 64 Kbps data channels plus 8 Kbps of control bits.

TFTP—Trivial File Transfer Protocol.

URL—Universal Resource Locator.

UPS—Uninterruptible Power Supply.

VPN—Virtual Private Network.

WAN—Wide Area Network.

WCCP—Web Cache Communication Protocol.

WIC—WAN Interface Card.

XML—extensible Markup Language.

2. Description of Related Art

U.S. Patent Documents

| | | |
|---|---|---|
| 5,987,606 | November 1999 | Cirasole, et al. |
| 6,161,133 | December 2000 | Kikinis |
| 6,240,462 | May 2001 | Agraharam, et al. |
| 5,970,477 | October 1999 | Roden |
| 6,249,527 | June 2001 | Verthein, et al. |
| 5,974,463 | October 1999 | Warner, et al. |
| 5,983,282 | November 1999 | Yucebay |
| 5,889,845 | March 1999 | Staples, et al. |

The ensoBox™ is an Internet Service Provider (ISP) appliance. An Internet appliance can be classified as a ready-to-use device that supports a specific Internet requirement. The software to support this appliance is pre-installed in the factory, is typically proprietary in nature, and is purchased in conjunction with the associated hardware. An appliance supports a plug-and-play configuration to allow for easy installation and management by the appliance's owner. An Internet appliance does not require the separate purchase of hardware and software, and then the subsequent systems integration by the owner.

An ISP appliance provides the functionality of an ISP into a device or cluster of devices where hardware and software are integrated in such a manner that the owner of the ISP appliance can be a fully functional, fully independent, self-supported ISP. An ISP appliance, at a minimum, should support the following basic ISP functions:

A direct connection to the Internet (T1 or higher speeds)

Dial-up access to the Internet

Basic features and functionality such as:

1. Security

2. Content filtering

3. Content caching

4. Data warehousing

5. DNS

A robust and flexible services offering including:

1. Web portal

2. Email

3. Web hosting

4. Chat

5. News

6. Anonymous FTP

7. Instant Messaging

8. Content packages (games, music, videos, auctions, news, etc.)

9. Video conferencing

10. e-Commerce Services (on-line shopping, banking, etc.)

Back office management software to allow an ISP Franchise to manage subscriber accounts, billing, trouble reporting, and performance monitoring.

The ensoBox™ meets all the above stated ISP requirements and was built to be flexible enough to expand for future Internet applications.

### BRIEF SUMMARY OF THE INVENTION

The ensoBox™ provides ISP Franchise subscribers with dial-up access to the Internet, features and functionality that are characteristic of ISPs, a suite of services including a Web Portal, email, web hosting, chat, news, and anonymous FTP, and access to the Internet (browsing the WWW). It also supplies an ISP Franchise owner with back office management software known as ensoOS™ that is required of an ISP to properly service and manage its subscriber base. ensoOS™ client software is installed on the ensoBox™, but is dependent on applications that are hosted at the ensoport.com™ data center. The data center is the home to the ensoOS™ Applications Infrastructure, which is responsible for all back office support for enoport.com™, Inc, and the ISP Franchises.

Refer to the ensoOS™ Technical Description for more details on ensoOS™ and Applications Infrastructure.

The ensoBox™ is comprised of three modular nodes referred to as the Core Node, Access Node, and Services Node. Each node performs a specific function and is dependent on one another to support all of the ISP features, functionality, and services offered by the ensoBox™. The ensoBox™ can be installed almost anywhere in the world, as long as there is proper power and facilities to meet the ensoBox™ environmental requirements (refer to the ensoBox™ Site Requirements Document for specific details). The basic Digital T1¹ configurations support between 4,000 and 8,000 subscribers. The basic Digital E1² and Analog P1³ configurations support between 5,000 and 10,000 subscribers. The ensoBox can be scaled to support up to 50,000 subscribers by adding Remote Access Servers (Cisco AS5300) to the Access Node. ¹ A standard ensoBox™ access node can be configured with 8, 12, or 16 T1and is known as the ensoBox™ Access Node T1 Digital 1000, ensoBox™ Access Node T1 Digital 1500, or ensoBox™ Access Node T1 Digital 2000 respectively. ² A standard ensoBox™ access node can be configured with 8, 12, or 16 E1s and is known as the ensoBox™ Access Node E1 Digital 1 000, ensoBox™ Access Node E1 Digital 1500, or ensoBox™ Access Node E1 Digital 2000 respectively. ³ A standard ensoBox™ access node can be configured with 240, 360, Or 480 analog modems and is known as the ensoBox™ Access Node P1 Analog 1000, ensoBox™ Access Node P1 Analog 1500, or ensoBox™ Access Node P1 Analog 2000 respectively.

The ensoBox™ currently provides dial-up access to services and the Internet only. Subscribers can connect to the ensoBox™ via a 56 Kbps analog phone line. In the future, the ensoBox™ will offer ISDN, high speed DSL, and wireless access. Subscribers are identified by a unique userid/password combination and are required to supply that information each time a dial up session to the ensoBox™ is established. All subscribers have access to a web portal, email, web hosting, chat, news, and anonymous FTP. In the future, ISP Franchises will be able to offer pay services (above the standard pricing) for services such as video conferencing, games, etc.

### BRIEF DESCRIPTION OF THE SEVERAL VIEWS OF THE DRAWING

For a fuller understanding of the present invention, reference is made to the following detailed description taken in conjunction with the accompanying drawing figures wherein like reference character denote corresponding parts throughout the several views and wherein:

FIG. 1 depicts the access node configuration;

FIG. 2 shows DNS resolution;

FIG. 3 shows dial access;

FIG. 4 shows how services are accessed;

FIG. 5 depicts the network design of the ensoBox;

FIG. 6 depicts the network design of the Core Node;

FIG. 7 depicts the network design of the Access Node;

FIG. 8 depicts the network design of the Services Node;

FIG. 9 shows the Core Node rack configuration;

FIG. 10 shows the Access Node rack configuration;

FIG. 11 shows the Services Node rack configuration;

### DETAILED DESCRIPTION OF THE INVENTION

ensoBox™ Overview

The ensoBox™ provides ISP Franchise subscribers with dial-up access to the Internet, features and functionality that are characteristic of ISPs, a suite of services including a Web Portal, email, web hosting, chat, news, and anonymous FTP, and access to the Internet (browsing the WWW). It also supplies an ISP Franchise owner with back office management software known as ensoOS™ that is required of an ISP to properly service and manage its subscriber base. ensoOS™ client software is installed on the ensoBox™, but is dependent on applications that are hosted at the ensoport.com™ data center. The data center is the home to the ensoOS™ Applications Infrastructure, which is responsible for all back office support for enoport.com™, Inc, and the ISP Franchises.

Refer to the ensoOS™ Technical Description for more details on ensoOS™ and Applications Infrastructure.

The ensoBox™ is comprised of three modular nodes referred to as the Core Node, Access Node, and Services Node. Each node performs a specific function and is dependent on one another to support all of the ISP features, functionality, and services offered by the ensoBox™. The ensoBox™ can be installed almost anywhere in the world, as long as there is proper power and facilities to meet the ensoBox™ environmental requirements (refer to the ensoBox™ Site Requirements Document for specific details). The basic Digital T1⁴ configurations support between 4,000 and 8,000 subscribers. The basic Digital E1⁵ and Analog P1⁶ configurations support between 5,000 and 10,000 subscribers. The ensoBox can be scaled to support up to 50,000 subscribers by adding Remote Access Servers (Cisco AS5300) to the Access Node. ⁴ A standard ensoBox™ access node can be configured with 8, 12, or 16 T1s and is known as the ensoBox™ Access Node T1 Digital 1000, ensoBox™ Access Node T1 Digital 1500, or ensoBox™ Access Node T1 Digital 2000 respectively. ⁵ A standard ensoBox access node can be configured with 8, 12, or 16 E1s and is known as the ensoBox™ Access Node E1 Digital 1000, ensoBox™ Access Node E1 Digital 1500, or ensoBox™ Access Node E1 Digital 2000 respectively. ⁶ A standard ensoBox™ access node can be configured with 240, 360, Or 480 analog modems and is known as the ensoBox™ Access Node P1 Analog 1000, ensoBox™ Access Node P1 Analog 1500, or ensoBox™ Access Node P1 Analog 2000 respectively.

The ensoBox™ currently provides dial-up access to services and the Internet only. Subscribers can connect to the ensoBox™ via a 56 Kbps analog phone line. In the future, the ensoBox™ will offer ISDN, high speed DSL, and wireless access. Subscribers are identified by a unique userid/password combination and are required to supply that information each time a dial up session to the ensoBox™ is established. All subscribers have access to a web portal, email, web hosting, chat, news, and anonymous FTP. In the future, ISP Franchises will be able to offer pay services (above the standard pricing) for services such as video conferencing, games, etc.

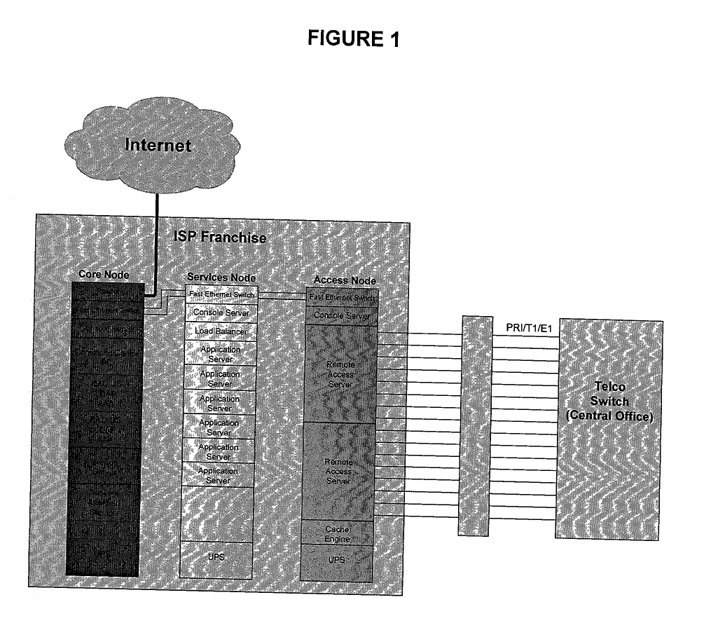

FIG. 1 is a high level depiction of the ensoBox™, its nodes, and its components.

ensoBox™ Scalability

The ensoBox™ is engineered using a modular approach to make scalability an easy task. It is comprised of nodes that serve a specific purpose. One node, the Access Node, is responsible for Internet access. A second node, the Core Node, is responsible for routing, security, data storage, and data backup. The third node, or Services Node, is responsible for offering services.

What makes the ensoBox™ scalable is the fact that new services and features can be added with the addition of a new node. For example, the current Access Node supports only dial access. Future versions of the ensoBox™ will support dedicated access via a Dedicated Access Node, high-speed access (DSL) via a High Speed Access Node, and e-Commerce services through the addition of an e-Commerce Services Node. As new technologies are introduced, the ensoBox™ can be scaled to implement those new technologies with the addition of a new node.

The Access Node and Services Node are both connected to the Core Node using redundant Fast Ethernet (100 Base-TX) connections. Additional nodes are connected to the Core Node using redundant Fast Ethernet (100 Base-TX) connections as well.

This kind of system architecture allows the ensoBox™ to always be a state-of-the-art ISP appliance. A modular design allows ISP Franchises to upgrade hardware and software, while simultaneously phasing out the old technology. For example, as the ISP Franchise expands and it's subscriber base grows from 10,000 users to 100,000 users, it may be feasible to add a more high-powered, process-intensive Core Node that is comprised of upgraded routers, switches, and servers. However, this new node can operate simultaneously with the old Core Node. This gives the ISP Franchise the flexibility to phase in the new Core Node and slowly phase out the old Core Node, or have both nodes operate in a primary/secondary fashion where the old Core Node can become a backup option to the new Core Node. This is just one example of the flexibility the ensoBox™ offers an ISP Franchise, as many other upgrade scenarios can be accommodated.

ensoBox™ Functional Description

The ensoBox™ provides features, functionality, services, and back office management support required for running an ISP business. From the standpoint of an ISP Franchise, the ensoBox™ provides the tools required to operate a successful ISP. These tools are called ensoOS™ and allow ISP Franchise's to perform:

Franchise Management Tools

Subscriber provisioning

Subscriber account management

Subscriber billing

Local network monitoring and management of the ensoBox™

Subscriber Access

From the standpoint of a franchise subscriber the ensoBox™ provides entry points to the Internet from anywhere in the world. A subscriber can access the Internet by simply dialing a local telephone number using an analog modem and a computer. Upon initiating a dial request to an ensoBox™, a subscriber is challenged to enter a valid userid/password to make a successful connection. If the subscriber is validated he can browse the Internet or access services offered by the ensoBox™. These services are called ensoServices™ and include ensoPortal™, ensoMail™, ensoChat™, ensoNews™, ensoWeb™ (web hosting service), and anonymous FTP. ensoVDO™ (video conferencing service) will be offered at a future date. To access services, a subscriber must direct his browser to the ensoPortal™ homepage where the subscriber will be challenged to enter a userid/password. If the subscriber is validated service icons will show up on his ensoPortal™ homepage, which allows the subscriber to read/send his email messages, create/view/modify his personal web page, chat with other ensoBox™ subscribers, enter newsgroups, or download files from an anonymous FTP server. The subscriber interface is a standard web browser such as Netscape Navigator or Internet Explorer.

All of the equipment and a majority of the services software are commercial off the shelf (COTS) components. That means they are widely available and supported world-wide. ensoOS™ is ensoport.com™, Inc. proprietary software, which means it cannot be commercially reproduced by anybody other than ensoport.com™. The ensoOS™ will be supported by the ensoport.com™ NOC.

Nodes

The ensoBox™ is an integration of three nodes: Core Node, Access Node, and Services Node. Alone, each node solves only a piece of the ISP puzzle. However, when integrated together, the ensoBox™ offers dial up access to the Internet, a toolbox of services for subscribers, a means for ISP Franchises to properly manage and bill subscribers, and a means by which ISP Franchises can settle monthly payments to ensoport.com™, Inc.. Each node performs specific tasks, and tasks performed by one node feeds other tasks performed at the other two nodes. This type of architecture allows for ease of management and scalability of the ensoBox™ and its components. The ensoBox™ is designed to grow as an ISP business grows, and it makes this growth affordable and manageable for the ISP Franchise.

The following paragraphs discuss the functionality of each node in more detail.

The Core Node

The Core Node is the “middle man” between the Internet and the Public Switched Telephone Network (PSTN). It connects directly to the Internet via a PRI (T1 or E1), T1, or E1. It also connects directly to the Access Node, which, in turn, connects to the public telephone network (PSTN) via multiple PRIs, T1s, E1s, or POTS analog lines. It links the components of all three (3) nodes together.

The Core Node is the intermediary between subscribers and their access to the Internet and ensoServices™. These services (web portal, web hosting, email, news, and chat) reside on application servers that are located in the Services Node (see Services Node section for more details). The Core Node supports subscriber authentication, authorization, and accounting (AAA). AAA functionality is supported by a RADIUS server and LDAP server located within the Core Node. AAA controls subscriber access to services and web browsing. AAA records (subscriber, call start time, call end time) are collected by the RADIUS server and used to feed the ensoport.com™ billing system. DNS servers within the Core Node provide primary DNS for services resolution, while Internet address resolution is provided by DNS servers at the ensoport.com™ data center. The ensoBox™ also provides secondary DNS for Internet address resolution.

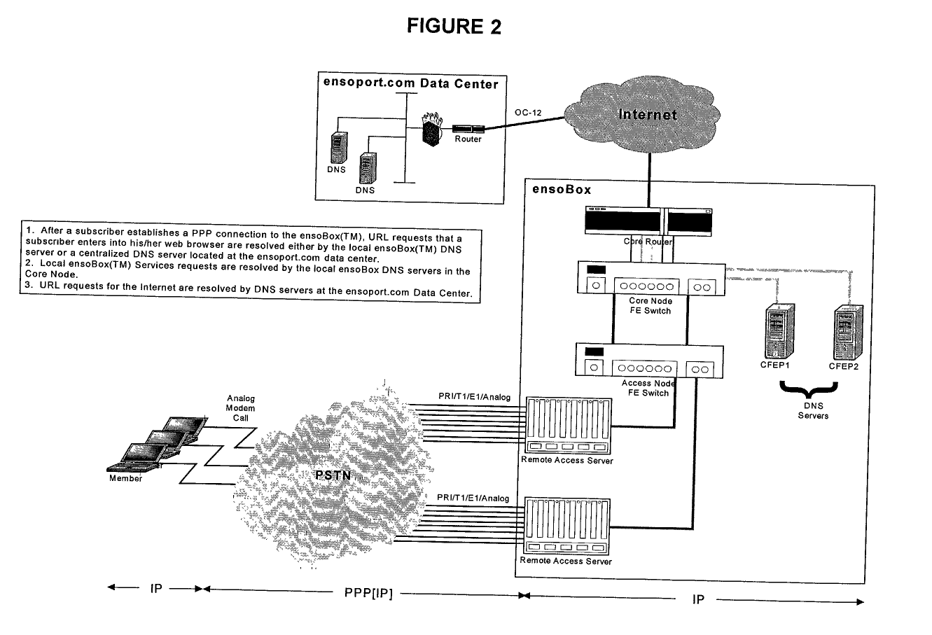

FIG. 2 describes DNS resolution.

The Core Node provides data storage for all subscriber data (portal, email, web hosting, account data, etc.) via a Network Attached Storage (NAS) device. A Tape Jukebox stores daily, weekly, and monthly backups of all the ensoBox™ data, operating system images, and equipment software images. Data backups are done by the Backup Server, and can be scheduled daily, weekly, monthly, etc., as well as either full or partial backups.

The Core Node provides VPN connectivity between the ensoBox™ and ensoport.com™ data center. This allows the ensoBox™ to securely communicate with back office ensoOS™ management systems located at the data center. The VPN is IPSec compliant and uses Cisco routers on each end of the VPN tunnel. The ensoBox™ does comply with all IPSec regulations for encryption in countries outside the United States.

The Access Node

The Access Node supports dial up connectivity (56 Kbps) to subscribers, and stores web content at the edge of the Internet, which reduces Internet network delay and improves subscriber response time for downloading information from the Internet. The Access Node (base configuration) consists of multiple PRIs, T1s, E1s, or POTS analog lines and supports up to 10,000 subscribers. Additional subscribers are supported by adding more Remote Access Servers (Cisco AS5300) and telephone circuits (PRIs, T1s, E1s, or POTS) to the Access Node, which can be easily scaled to support up to 50,000 subscribers.

Content Caching

The Access Node contains a cache engine that stores Internet content locally within the ensoBox™. This improves subscriber response time by eliminating network delay when retrieving information from the Internet. Network delay is reduced for two reasons:

1. 40-50% of Internet content (static objects) is stored locally in the cache engine. This eliminates the delay for retrieving information on the Internet.

2. Services are supported locally at the ensoBox™ instead of at a data center located somewhere on the Internet. This eliminates both Internet backbone delay and server processing delay (the ensoBox™ servers support between 10,000 and 50,000 subscribers, whereas data center servers support millions of subscribers).

Overall, approximately 70% of subscriber requests are processed at the edge of the Internet by the ensoBox™.

The cache engine also reduces the bandwidth required by the direct connection to the Internet. Because of the cache engine and the fact that server processing is being done locally, the bandwidth required for connecting to the Internet is reduced. In a distributed model such as the ISP Franchise Model, where 70% of subscriber requests are processed locally, this bandwidth can be reduced to a T1 or E1.

The cache engine also allows the ISP Franchise to implement specific content filtering rules to prevent access to unwanted material on the Internet.

The way a cache engine works is that every time a subscriber requests information from the Internet, the ensoBox™ will check to see if any of the requested information is already stored in the cache engine (which means it has been requested previously). If the cache engine does not contain the requested Internet data, or the data is no longer valid (expired), then it retrieves the data from the Internet and serves it back to the subscriber. However, the cache engine now stores that data and can serve it locally upon future requests for the same data until its validity expires.

Dial Access

Subscribers dial into the Access Node over the public telephone network using a modem and standard dial-up networking software on their computer. Prior to placing the call, the subscriber enters a valid userid/password into the dial-up networking window. When a subscriber dials the ensoBox™ telephone number, the call is routed to one of the modem ports on the Remote Access Server (if no port is available the subscriber will get a busy signal and will have to initiate the call again). The modem port accepts the call, dynamically assigns an IP address to the subscriber's computer, and forwards the userid/password to the RADIUS server. The userid/password is sent over the telephone network via PAP (Password Authentication Protocol). The RADIUS server compares the userid/password to a list of valid userid/password combinations on the LDAP server. If there is a match with the LDAP database, the RADIUS server accepts the call, sends authorization back to the subscriber's computer, and establishes a PPP (Point-to-Point Protocol) session between the ensoBox™ and the subscriber's computer. The RADIUS server tracks the length of the call for accounting purposes. If the userid/password is incorrect, the call is terminated and the subscriber must re-initiate a connection with the ensoBox™.

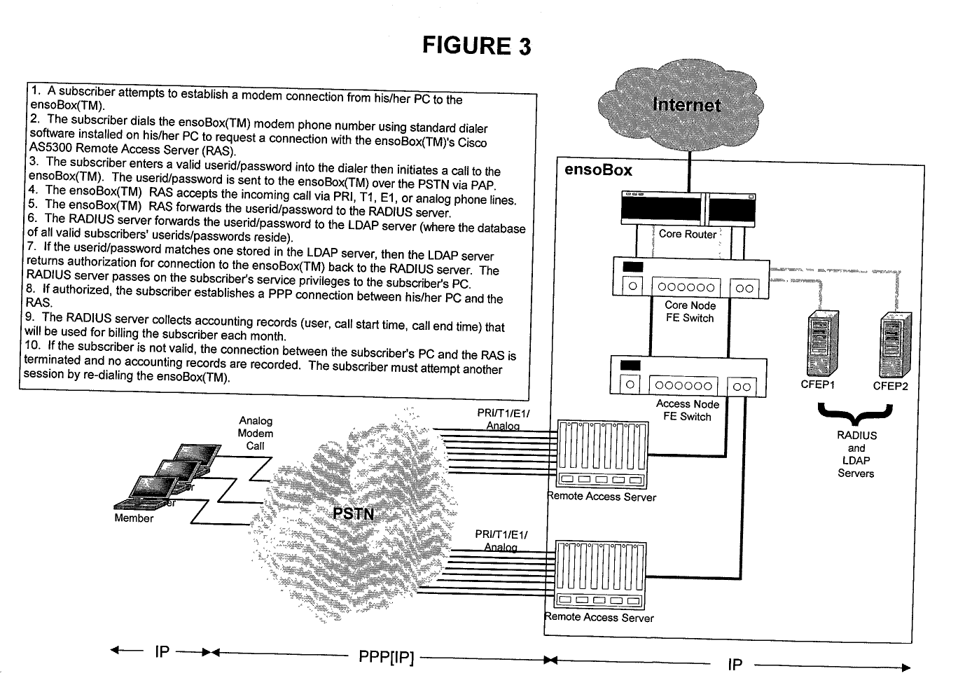

FIG. 3 depicts the process for dialing into the ensoBox™.

The Access Node connects directly to the PSTN via eight (8), twelve (12), or sixteen (16) T-1 or E-1 circuits. The following standard Access Node configurations are available:

TABLE 1
ensoBox ™ 1000 Series

| ensoBox ™ Digital 1000 and | ensoBox ™ Access | ensoBox ™ Access | ensoBox ™ Access |
|---|---|---|---|
| Analog 1000 Series Properties | Node T1 Digital 1000 | Node E1 Digital 1000 | Node P1 Analog 1000 |
| Total number of users per | 3840 | 4800 | 4800 |
| ensoBox ™ 1000 Access Node⁷ | | | |
| Total Number of 56 kbps | 192 | 240 | 240 |
| analog/64 kbps ISDN modem | | | (Analog Only) |
| ports per ensoBox ™ 1000 Node | | | |
| Total Number of T1s/E1s per | 8 | 8 | N/A |
| ensoBox ™ 1000 Access Node | | | |

TABLE 2
ensoBox ™ 1500 Series

| ensoBox ™ Digital 1500 and | ensoBox ™ Access | ensoBox ™ Access | ensoBox ™ Access |
|---|---|---|---|
| Analog 1500 Series Properties | Node T1 Digital 1500 | Node E1 Digital 1500 | Node P1 Analog 1500 |
| Total number of users per | 5760 | 7200 | 7200 |
| ensoBox ™ 1500 Access Node⁸ | | | |
| Total Number of 56 kbps | 288 | 360 | 360 |
| analog/64 kbps ISDN modem | | | (Analog Only) |
| ports per ensoBox ™ 1500 Node | | | |
| Total Number of T1s/E1s per | 12 | 12 | N/A |
| ensoBox ™ 1500 Access Node | | | |

TABLE 3
ensoBox ™ 2000 Series

| ensoBox ™ Digital 2000 and | ensoBox ™ Access | ensoBox ™ Access | ensoBox ™ Access |
|---|---|---|---|
| Analog 2000 Series Properties | Node T1 Digital 2000 | Node E1 Digital 2000 | Node P1 Analog 2000 |
| Total number of users per | 7680 | 9600 | 9600 |
| ensoBox ™ 2000 Access Node⁹ | | | |
| Total number of 56 kbps analog/64 | 384 | 480 | 480 |
| kbps ISDN modem ports per | | | (Analog Only) |
| ensoBox ™ 2000 Access Node | | | |
| Total Number of T1s/E1s per | 16 | 16 | N/A |
| ensoBox ™ 2000 Access Node | | | |

⁷Assumes a 20:1 modem ratio and appropriate telecommunications connectivity is met.
⁸Assumes a 20:1 modem ratio and appropriate telecommunications connectivity is met.
⁹Assumes a 20:1 modem ratio and appropriate telecommunications connectivity is met.

The Services Node

The Services Node offers a variety of services including:

1. Web Portal

2. Email

3. Chat

4. News

5. Web hosting

6. Anonymous FTP

The Services Node is designed with network uptime and efficiency in mind. Services are installed on six (6) application servers to protect against server failures. A load balancer (Cisco's CS-50 Content Smart Switch) is used to balance server-processing loads across all of the application servers and to reroute requests to a different server when one of the servers fails. The distribution of subscriber requests across multiple servers improves subscriber response times because the load balancer always routes requests to the server experiencing the least amount of processing load at that moment. This type of services architecture provides a high availability of services and a low latency for the subscriber.

Clustered Services Architecture (CSA)

The Services Node is powered by a Clustered Services Architecture (CSA). CSA defines a standard architecture for the Service Provider market. This approach integrates best of breed hardware and software to deliver a network architecture capable of delivering Internet services in a reliable manner. This configuration will scale independently as the subscriber base and service offerings grow. This approach uses lower-end hardware and software from best of breed hardware and software manufacturers that allows the ISP Franchise to scale incrementally.

For more information about CSA, refer to the CSA Technical Description.

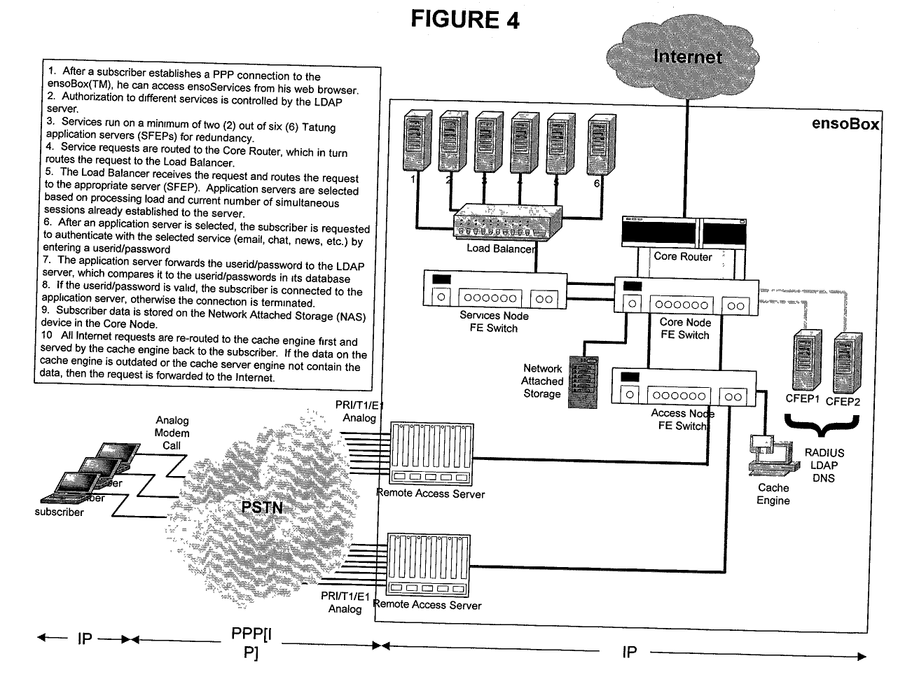

FIG. 4 shows the process for access services.

ensoOS™

The ISP Franchise has at its disposal a suite of back office management systems to manage its ISP business. All back office systems are developed and supported by ensoport.com™, Inc. The back office management systems utilize a client-server network architecture, where client software runs on the ensoBox™ and server software runs at the ensoport.com™ data center. Communications between the ensoBox™ and ensoport.com™ data center is secured through a Virtual Private Network (VPN).

ensoOS™ allows the ISP Franchise to provision subscribers, manage subscriber accounts, bill subscribers, access reports, and monitor the ensoBox™. These applications are part of the ensoOS™ tools and consist of the following:

ensoAdmin—creates Franchise subscribers and assigns them to group-based services.

Service Builder—creates service policies and service plans for flexible billing models.

Account Manager—add, delete, and modify subscriber accounts and assign service plans to subscribers.

Provisioner—receives requests from Account Manager, and uses information input into Account Manager and creates an account in the subscriber database.

Biller—creates bills to bill subscribers based on system usage and service plan. It also provides monetary settlement between Franchises and ensoport.com™, Inc.

Report Manager—creates business reports to analyze everything from network utilization to help desk ticket response time.

Help Desk—a means for subscribers to resolve problems with their ISP service.

Command Center—monitors system usage and utilization.

For more details about ensoOS™ and Applications Infrastructure refer to the ensoOS™ Technical Description.

Network Monitoring and Management

All components of the ensoBox™ are remotely monitored by the ensoport.com™ Network Operations Center (NOC) 24×7×365. ensoBox™ components are managed in one of three (3) ways:

1. Over the Internet via a telnet connection to the component's network interface.

2. Over the Internet via a telnet connection to an accompanying console server.

3. Via a direct dial connection to a serially attached modem.

Local network monitoring and management is provided by the Command Center. The Command Center is an ensoOS™ application that runs on the ensoBox™. SNMP traps set off alarms when failures occur and also provide real-time performance statistics of the ensoBox™ such as:

Bandwidth utilization.

Available memory.

CPU processing.

Port monitoring.

Modem monitoring.

Modem speed.

Modem usage.

Disk usage.

Cache efficiency (hit rates).

I/O statistics.

Disk usage.

NAS Filer usage.

Server monitoring.

Component temperatures.

ensoBox™ Features and Functionality

The following section describes the features and functionality of the ensoBox™. These features are traditionally standard for all ISPs and provide the foundation for supporting and growing a successful ISP business.

The ensoBox™ supports the following features and functionality:

Hot Deploy (remote server application management)

Time synchronization

PPP (Point-to-Point Protocol) dial up access

Password Authentication Protocol (PAP)

AAA (Authentication, Authorization, Accounting)

DNS

Dynamic source IP addressing

Network based data storage

Data backup

Content caching

Content filtering

Security

Hot Deploy

Hot Deploy is a means for the ensoport.com™ NOC to manage the operating system and applications installed on the application servers configured in the ensoBox™. It automatically installs the Sun Solaris operating system, related patches, software, system configuration parameters, ensoOS™, and ensoport.com™ developed services on the ensoBox™ Front End Processors (FEPs). In the event of a failure or server shutdown, Hot Deploy remotely restores the FEP operating system and software images.

Time Synchronization

Network Time Protocol (NTP) synchronizes the clock on all of the components of the ensoBox™. An NTP stratum one server uses the time (in Greenwich Mean Time) provided by Global Positioning Service (GPS) receivers. Stratum One servers are public domain and are located throughout the Internet. They are typically privately owned and operated to ensure precision time all the time. Servers, routers, switches, etc. synchronize their internal clocks with the NTP stratum one server to ensure clock consistency amongst the ensoBox™ components. This is important for supporting time critical applications and collecting accurate accounting records from the RADIUS server. Time synchronization ensures billing is correct and accurate.

Point-to-Point Protocol (PPP)

Subscribers' computers connect to the ensoBox™ modems via a PPP session. PPP is the Internet Standard for transmission of IP packets over serial lines. PPP supports asynchronous and synchronous communication lines. The standard for PPP is RFC 1661.

Password Authentication Protocol (PAP)

Subscriber authentication information (userid and password) is sent from the subscriber's computer to the ensoBox™ via Password Authentication Protocol. PAP is required to properly identify a subscriber prior to establishing a PPP connection to the ensoBox™.

PAP provides a simple method for a subscriber to establish its identity using a 2-way handshake. This is done only upon initial link establishment. After the link establishment phase is complete, a userid/password pair is repeatedly sent by the subscriber to the authenticator (in this case a RADIUS server) until authentication is acknowledged or the connection is terminated.

PAP is not a strong authentication method. Passwords are sent over the circuit “in the clear”.

AAA (Authentication, Authorization, Accounting)

The ensoBox™ uses a RADIUS server to perform AAA functions (authentication, authorization, and accounting). The RADIUS server uses an LDAP (Lightweight Directory Access Protocol) server to retrieve subscriber authorization information (a list of services the user is allowed to access). Real-time accounting records are generated on the RADIUS server. Accounting records are sent from the ensoBox™ RADIUS server to the data center on a daily basis and used by the Billing Tool to generate subscriber bills.

Authentication—verifying that the subscriber is a valid subscriber by entering a valid userid/password.

Authorization—assigned services that can be accessed by an authenticated subscriber.

Accounting—collecting usage records for the length of the subscriber dial session.

Domain Name Service (DNS)

The ensoBox™ supports primary DNS for access to locally stored ensoServices™ and Secondary DNS for web browsing. Primary DNS for web browsing is supported at the ensoport.com™ data center. ensoBox™ components use the top level domain name of ensoport.com, and all components of the ensoBox™ will use the following naming convention:

<component>.<franchise city>.ensoport.com

where <component> identifies the node where the component is installed (Core, Access, or Services Node), and the component's functionality (router, switch, etc.).

Refer to the component naming conventions under the ensoBox™ Components section of this document for more details about each component's DNS names.

Dynamic IP Addressing

The ensoBox™ Remote Access Server (RAS) assigns dynamic IP addresses to subscribers each time a subscriber dials into an ensoBox™. The IP address assigned at the time the dial session is initiated is the same IP address that will be assigned to the subscriber for the entire session. The IP address will be terminated upon termination of the dial-up session and returned to the IP address pool and assigned to a future subscriber that initiates a dial session. Two (2) Class C Internet addresses are assigned for every 10,000 subscribers.

Network Based Data Storage

The ensoBox™ uses a network attached storage (NAS) configuration to store end user data (email, web hosting information, files, etc.). Each subscriber is assigned a specific amount of storage space and will not be allowed to exceed that limit without authorization from his corresponding Franchise.

Data Backup

The ensoBox™ performs scheduled backups of all applications and data. Backups will be stored on a tape jukebox, and tapes will be stored in a safe location, protected from fire, water, and any other harmful agents. Backups can be done hourly, daily, weekly, monthly, etc., and either full or partial.

Content Caching

The ensoBox™ supports transparent content caching, where a local cache engine stores the most recently requested Internet data. If multiple subscribers request similar data, and the data's validity has not expired, then the data will be served from the local ensoBox™ cache engine instead of from the original web server located somewhere within the Internet. This reduces Internet network delay and improves end user response time.

Content Filtering

The cache engine also allows the franchise to implement specific content filtering rules to prevent access to unwanted material on the Internet.

Security

ensoBox™ security is handled in a layered approach with attention given to host based security as well as network based security.

Host based security uses Wietse Venema's tcp-wrappers and manual hardening. TCP-wrappers are tools designed to provide greater control over all connections to the secured host. The manual hardening process will disable all unneeded services that could potentially be abused.

Network based security will be two fold, consisting of encryption of communications and access controls on the internal LANs within the ensoBox™. The encryption is accomplished using existing VPN features of the Cisco 2621 router. The router is configured to provide encryption of connections between the ensoport.com™ data center and the router within the ensoBox™. These connections are commonly referred to as VPNs. The other facet of network security involves securing access to the various networks within the ensoBox™. This is accomplished by designing the ensoBox™ such that equipment with similar access policies is located on similar Virtual LANs or VLANs. Access to VLANs is further protected by router based Access Control Lists (ACLs).

ensoServices™

The ensoBox™ offers the following services:

ensoPortal™

ensoMail™

ensoWeb™

ensoChat™

ensoNews™

anonymous FTP

ensoPortal™

The ensoPortal™ organizes subscriber data in such a way as to allow subscribers to more efficiently access ensoServices™ as well as other Internet-based services. The ensoPortal™ consists of hyperlinks to all of the ensoServices™ including ensoMail™, ensoNews™, ensoWeb™, ensoChat™, and anonymous FTP. All future ensoServices™ will be integrated into a subscriber's portal as well.

In addition to ensoServices™, the ensoPortal™ also contains links to most frequently accessed Internet resources such as search engines, local and international news, sports, financial news, games, personal information managers, etc. This information is tailored on a franchise-by-franchise basis to compensate for different subscribers' interests amongst each franchise.

ensoMail™

The ensoBox™ uses Communigate Pro email, which is a web based email application that supports POP3, ESMTP, IMAP, APOP, SSL, and other mail protocols. It integrates with LDAP so that subscriber provisioning is performed via the LDAP interface. It also supports web page publication, has anti-spam features, and a configurable web interface. While a subscriber cannot limit attachment size, he can limit the total size of any outgoing or incoming email message.

Subscribers access their mail through a standard web based user interface such as Netscape Navigator or Internet Explorer. Email sessions are secured via an SSL connection between the subscriber's computer and the ensoBox™ mail server. ensoMail™ can be accessed from anywhere on the Internet, regardless of whether or not the subscriber is directly connected to the ensoBox™ or not.

ensoWeb™

ensoWeb™ offers subscribers the capability to publish and maintain their own web site. In addition, Communigate Pro supports a web page module that allows subscribers to upload web pages that they have already created elsewhere. Subscribers will be subject to quotas on both disk space and number of files stored. Requests for additional disk space are handled by the ISP Franchise.

ensoChat™

ensoChat™ offers subscribers a real-time chat application. Subscribers can chat with other ensoBox™ subscribers on any topic they wish. ensoChat™ is a standard service offering that is available to all subscribers. Access to ensoChat™ services is through the ensoPortal™.

ensoNews™

ensoNews™ allows subscribers to access Usenet newsgroups through the ensoPortal™. ensoNews™ is a standard service offering available to all subscribers.

Usenet News is a world-wide discussion and conferencing system. Subscribers can submit messages to specific news groups related to their message topic (e.g., arts, science, literature, sports). Messages are posted on a local news server. Local news servers distribute news group messages to other news servers throughout the world using the Internet. To read messages, individuals access their local news server and download messages of interest.

Newsgroups are arranged in a tree structure such as rec.sport.baseball.pro. The suffix rec. is the top of the tree. The ensoBox™ news servers will be used by subscribers to read messages of interest.

anonymous FTP

This service allows subscribers to download Internet shareware from the ensoBox™. Shareware will be downloaded to an ensoBox™ FTP server by ensoport.com™ NOC personnel. Once the shareware is downloaded to an ensoBox™, subscribers can download the information to their computer by establishing an anonymous FTP session to the ensoBox™ anonymous FTP server.

ensoVDO™

ensoVDO™ is a standards based video conferencing service that is available to all subscribers. Unlike most of the other services, video conferencing is a fee based service, and is not part of the standard suite of ensoServices™.

Technical Description

Technical Overview

The ensoBox™ is an integration of telecommunications hardware and software, including a router, Fast Ethernet switches, Remote Access Servers, a Caching Appliance, Load Balancer, DNS servers, MA servers, application servers, and a network based data storage system. The integration of these components provides the functionality of an ISP appliance. It allows subscribers to remotely access the Internet through dial-up modems. It also offers a suite of services called ensoServices™ that includes: web portal, email, web hosting, chat, and news. Lastly, it provides all of the necessary tools for an entrepreneur to build and manage a successful ISP Franchise.

The functionality of the ensoBox™ is divided into three modules, or nodes, called the Core Node, Access Node, and Services Node. Each node contains a Console Server (Black Box 40871 Terminal Server) that allows the ensoport.com™ Network Operations Center (NOC) to remotely manage each component of the ensoBox™. Remote management is achieved in this manner by initiating a telnet session to the console server, and then initiating another telnet session from the Console Server to the appropriate hardware component. Component management can also be achieved by establishing a telnet session directly to each component's network interface port (each component, including the UPS, has a Public IP address associated with it), or by dialing into each component directly via a serially attached modem. Management through a modem is available in the event there is no Internet connectivity to the ensoBox™. Each node also consists of a 10/100 Mbps auto-sensing Fast Ethernet switch (Cisco Catalyst 2924) that is used to connect ensoBox™ components to one another and support Virtual Local Area Networks (VLANs). The ensoBox™ is configured with five (5) VLANS:

TABLE 4
VLAN Descriptions

| VLAN Name | VLAN Number | VLAN Color |
|---|---|---|
| Services | 100 | GREEN |
| Management | 200 | PINK |
| Core | 300 | YELLOW |
| Franchise | 400 | BLUE |
| Subscribers | 500 | RED |

VLANs ensure that ensoBox™ services and components are accessed by authorized people only. For example, the Management VLAN ensures that only the ensoport.com™ NOC can access components through that VLAN. It is off limits to subscribers, ISP Franchises, etc.

Two Public Class C IP addresses support dynamic IP addressing for dial-up subscribers. A third Public Class C IP address is used to address the ensoBox™ components. The one (1) Public Class C IP address used for addressing the ensoBox™ components is subnetted into 4 subnets where each subnet supports up to 62 hosts (each subnet consists of 64 IP addresses, but one IP address is reserved for the network address and a second IP address is reserved for the broadcast address). In terms of classless IP addressing, each component network has a CIDR suffix of /26. The two Class C IP addresses reserved for dynamic IP addressing of remote users has a CIDR suffix of /24. The network addresses for each VLAN are as follows:

TABLE 5
VLAN Network Addressing

| VLAN Name | VLAN Number | VLAN Address |
|---|---|---|
| Services | 100 | A.B.C.0/26 |
| Management | 200 | A.B.C.128/26 |
| Core | 300 | A.B.C.64/26 |
| Franchise | 400 | A.B.C.192/26 |
| Subscribers | 500 | A.B.X.0/24 |
| | | A.B.Y.0/24 |

Each node contains one (1) Uninterruptible Power Supply (UPS), the APC Smart-UPS 3000 RM 5U (Latin America and Asia)¹⁰, that can provide emergency power to the failed node for five (5) to ten (10) minutes in the event of a power failure on the main source of power. This is enough time to properly power down the ensoBox™ and power it back up using a reserve generator. The UPS supports either a 230 V AC input circuit. ¹⁰ The APC Smart-UPS 3000 RM 3U T is used in the United States.

Core Node

The Core Node serves several functions including access to and from the Internet, routing between components, and routing between VLANs. A Cisco 2621 router provides a direct connection to the Internet and supports six (6) network connections:

1-10/100 Mbps auto-sensing Fast Ethernet connection to the Services Network

1-10/100 Mbps auto-sensing Fast Ethernet connection to the Core Network

1-100 Mbps Ethernet connection to the Management Network

1-10 Mbps Ethernet connection to the Franchise Network

2-10 Mbps Ethernet connections to the Subscribers Network

The Core Node is also responsible for data storage and data backup for the ensoBox™. A Network Attached Storage (NAS) device provides primary storage for subscribers' data, component software images, etc. A tape backup device performs daily, weekly, and monthly backups of all ensoBox™ data including email messages, web hosting files, subscriber files, services and software images. The tape jukebox can store up to 560 GB of data (compressed) or 280 GB of data (native). This solution provides for a quick recovery of lost data and/or services in the event of a failure to the ensoBox™.

Access Node

The Access Node supports dial connectivity to the ensoBox™. Subscribers can access ensoServices™ and the Internet by dialing into modems installed in the Access Node. Two (2) Cisco AS5300 Remote Access Servers (RAS) support all dial-up sessions. Each AS5300 can be configured with up to eight (8) T1s or eight (8) E1s, for a total of sixteen (16) per ensoBox™. Each T1 can support up to twenty-four (24) simultaneous remote dial sessions, and each E1 can support up to thirty (30) simultaneous remote dial sessions. A fully configured ensoBox™ (16 T1s or E1s) can support up to 384 simultaneous dial sessions (for T1 connectivity) or up to 480 simultaneous dial sessions (for E1 connectivity). The ensoBox™ can alternatively be configured with 240, 360, or 480 analog circuits.

A Cisco CE-505 Cache Engine is used to cache the most requested Internet data by subscribers. This does two things: it reduces network delay by storing more content locally, and it improves end user response time. The CE-505 and Cisco 2621 run WCCP version 2.0.

Services Node

The Services Node consists of six (6) application servers that support the web portal, email, chat, news, web hosting, and video conferencing (future service). Each service runs on six (6) application servers to ensure a high availability of services to subscribers. A Cisco CS-50 Content Smart Switch balances subscriber sessions amongst the application servers based on server load and server availability.

Server Stickiness

It is critical for subscribers to communicate with one mail server once an email session is established. To accomplish this, the CS-50 is configured with a “sticky” parameter that maintains a connection between the subscriber and a single mail server based on the Session ID (SID) established at the start of the mail session. In the event of a mail server failure, the session is permanently lost and the subscriber is redirected to an operational mail server at the time the service is requested again. However, the subscriber has to initiate a new mail session with the new mail server.

Spares Kit

Each ensoBox™ is shipped with a spares kit that includes:

1—Cisco 2621 router

1—Cisco Catalyst 2924 Fast Ethernet switch

1—Cisco CS-50 Content Smart Switch

1—Tatung workstation

1—DLT7 Tape Jukebox

1—Black Box Console Server

1—APC UPS

Network Design

The functional goal of the ensoBox™ is to provide services and Internet access to ISP Franchise subscribers, while also providing the back office management software required to run an ISP business. The design takes into account the need to add new features and functionality, add new services, and be able to support a growing subscriber base. The following description describes how the ensoBox™ is designed to meet optimal performance requirements and scale to meet technology changes and subscriber demands for new services.

The ensoBox™ connects directly to the Internet via a direct T1 or E1 Internet connection from an ISP. If a direct Internet connection is not available, then the ensoBox™ connects to the Internet via a satellite connection. The Internet connection is supported via a Serial WAN port on the Core Node Router (Cisco 2621 router). The Core Node Router then connects to the ensoBox™ VLANs through six (6) network router ports, two (2) of which are 10/100 Mbps auto-sensing Fast Ethernet ports and four (4) of which are 10 Mbps Ethernet ports.

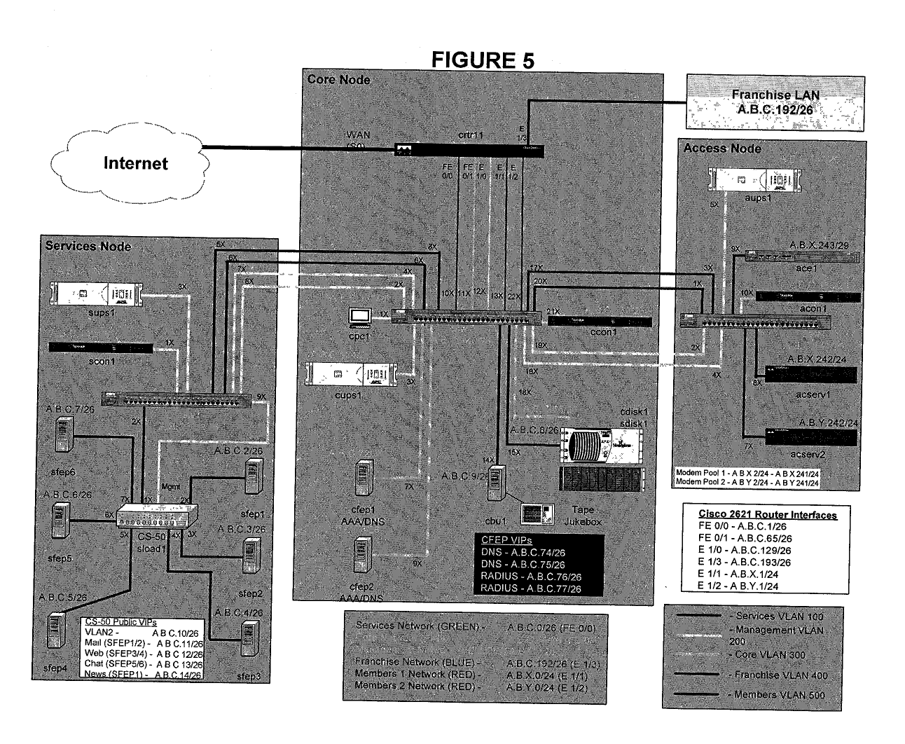

FIG. 5 depicts the network design of the ensoBox™.

Core Node

The Core Node Router is connected to six (6) 10/100 Mbps auto-sensing ports on the Core Node Switch (Cisco Catalyst 2924 Fast Ethernet switch). These six (6) connections support five (5) VLANs, including the Core, Services, Management, Franchise, and Subscribers VLANs. The Subscribers VLAN is supported through two (2) network connections from the router, while the other four (4) VLANs are supported by one (1) network connection each from the router.

The Core Node supports RADIUS, LDAP, and DNS using two (2) Tatung Model U10/440 Sun Ultra 10 Compatible SPARC Workstations. A third server supports the data backup software for the tape jukebox (Benchmark DLT7 autoloader). RADIUS, LDAP, and DNS run on two (2) servers to ensure ensoBox™ operability in the event of a failure to one of the servers.

A Network Attached Storage (NAS) supports all data storage for the ensoBox™ including services data and subscriber data.

All Core Node components are connected to 10/100 Mbps auto-sensing Fast Ethernet ports on the Core Node Switch.

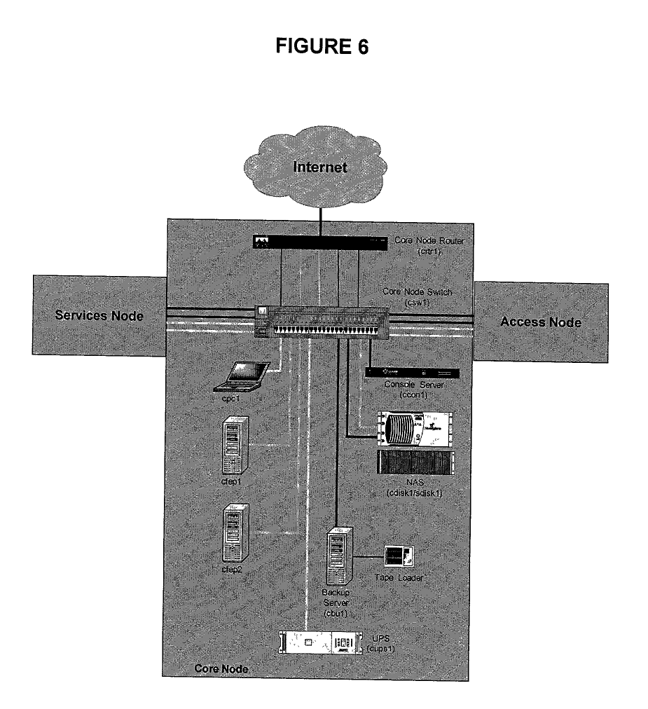

FIG. 6 depicts the network design for the Core Node.

Access Node

The Core Node Switch is connected to the Access Node Switch (Cisco Catalyst 2924 Fast Ethernet switch) in the Access Node via four (4) 10/100 Mbps auto-sensing Fast Ethernet circuits. Two (2) of those circuits support the Subscribers VLAN, and the other two (2) circuits support the Management VLAN. One (1) circuit per VLAN is sufficient to support traffic between the Core Node and Access Node, however, a second connection is used for redundancy in the event of a failure to one of the circuits.

The Access Node uses two (2) Remote Access Servers (Cisco AS5300) to support dial up connectivity. Each RAS is configured with either four (4), six (6), or eight (8) PRIs, T1s, or E1s that connect the ensoBox to the Public Switched Telephone Network (PSTN). With two (2) RAS' per ensoBox™, each ensoBox™ supports eight (8), twelve (12), or sixteen (16) PRIs, T1s, or E1s. Each RAS is configured with digital modems that allow subscribers to establish a dial up 56 Kbps connection to the Internet. The number of digital modems is dependant on the number of PRIs, T1s, or E1s that are connected to the RAS. A PRI/T1 can support twenty-four (24) digital modems, and a PRI/E1 can support thirty (30) digital modems. Subscribers are authenticated via the Core Node AAA Servers (RADIUS and LDAP). Services URL resolution to IP addresses is provided by the Core Node DNS servers, while Internet URL resolution is supported by DNS servers at the ensoport.com™ data center.

Routing

Subscriber data requests are switched from the Access Node Switch to the Core Node Router where they are then routed to the appropriate destination. If the destination is not within the ensoBox™ domain, but instead resides within the Internet, the Core Node Router uses a default route to the Internet for processing. If the request is for ensoServices™ that reside within the Services Node, the Core Node Router routes the request to the Core Node Switch, which in turn sends the request to the Services Node Switch, which then sends the request to the load balancer (Cisco CS-50 Content Smart Switch). The CS-50 determines which server will most efficiently process the request.

All Access Node components are connected to 10/100 Mbps auto-sensing Fast Ethernet ports on the Access Node Switch.

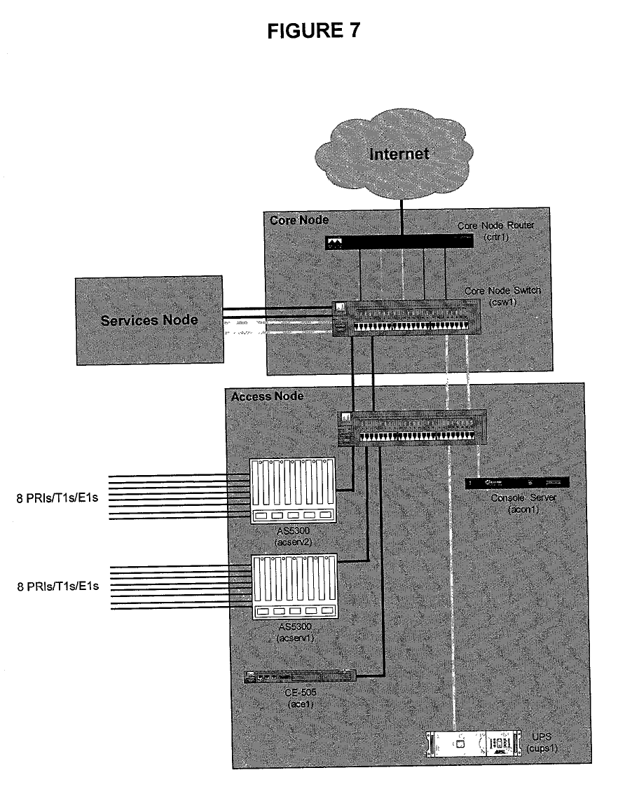

FIG. 7 depicts the network diagram of the Access Node.

Services Node

The Core Node Switch is connected to the Services Node Switch (Cisco Catalyst 2924 Fast Ethernet switch) via four (4) 10/100 Mbps auto-sensing Fast Ethernet circuits. Two (2) circuits carry Services VLAN traffic and the other two (2) circuits carry Management VLAN traffic. Two circuits per VLAN provide redundancy in the event of a circuit failure between the Core Node and Services Node.

Services run on six (6) Tatung Model U10/440 Sun Ultra 10 Compatible SPARC Workstations. The Tatung workstations support the ensoServices™ including ensoPortal™, ensoMail™, ensoWeb™, ensoNews™, ensoChat™, and anonymous FTP. Services run on all six (6) servers to provide a high service availability solution. The servers are connected to a load balancer (Cisco CS-50 CSS) that intelligently routes server requests to the most efficient server available based on server load and number of concurrent TCP sessions per server.

All Service Node components (other than the servers) are connected to 10/100 Mbps auto-sensing Fast Ethernet ports on the Services Node Switch.

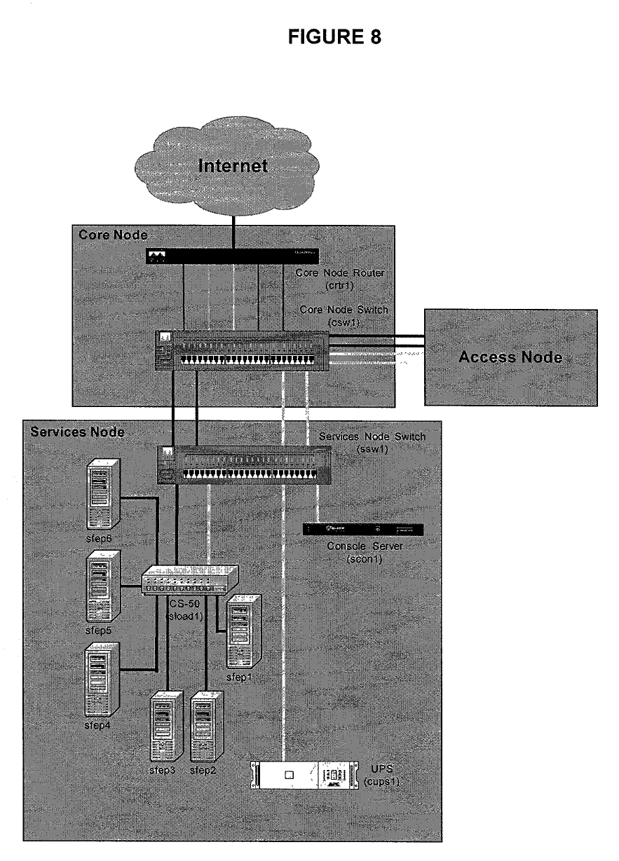

FIG. 8 depicts the network design of the Services Node.

ensoBox™ Components

Core Node Components

The Core Node is comprised of the following components:

Black Box 40871 Terminal Server (Console Server)

Cisco 2621 Router

Cisco Catalyst 2924 XL 10/100 Autosensing Fast Ethernet Switch

Network Appliance F720 File Server (Network Attached Storage)

Benchmark DLT7 Autoloader

Tatung Model U10/440 Sun Ultra 10 Compatible SPARC Workstations (3)

APC Smart-UPS 3000 RM 3U T

Component descriptions can be found in Appendix A.

Core Node Router

Each router port supports a single network within the ensoBox™ as follows:

TABLE 6
Core Node Router Networks

| Router Port | Network |
|---|---|
| S0 | Default route to the Internet |
| S1 | Inactive |
| FE 0/0 | Services Network |
| FE 0/1 | Core Network |
| E 1/0 | Management Network |
| E 1/1 | Subscribers Network |
| E 1/2 | Subscribers Network |
| E 1/3 | Franchise Network |

The router supports a static route to the primary Internet provider in country (i.e.—UUNet or a VSAT connection). The router's default route is the next hop Internet provider's router. The ensoBox™ router is not configured to run any routing protocols (i.e,—RIP, OSPF, BGP-4, etc.) at this time, but may be configured as such in the future.

Core Node Switch

The Core Node switch supports all five (5) ensoBox™ VLANs, including the Management VLAN, Services VLAN, Core VLAN, Franchise VLAN, and Subscribers VLAN.

Through Cisco's Switch Clustering technology, additional switches can easily be added to the ensoBox™ configuration without making significant changes to the current ensoBox™ switches. Switch Clustering technology also allows management of all the ensoBox™ switches through a single switch instead of each switch individually.

Core Node Servers

Two (2) of the Core Node Tatung servers are responsible for supporting RADIUS, LDAP, and DNS. These services run on two (2) servers for redundancy. The third Tatung workstation runs the backup software that performs backups to the Benchmark DLT7 tape jukebox.

Core Node Component Naming Convention

The following table describes the naming convention for the Core Node components.

TABLE 7
Core Node Component Naming Convention

| Core Node Component | DNS Name |
|---|---|
| Core Node Console Server | ccon1.<franchise city name>.ensoport.com |
| Core Node Router | crtr1.<franchise city name>.ensoport.com |
| Core Node Switch | csw1.<franchise city>.ensoport.com |
| Core Node Servers | cfep1.<franchise city>.ensoport.com |
| | cfep2.<franchise city>.ensoport.com |
| | cfep3.<franchise city>.ensoport.com |
| Backup Server | cbu1.<franchise city>.ensoport.com |
| NAS (Core VLAN) | cdisk1.<franchise city>.ensoport.com |
| NAS (Services VLAN) | sdisk1.<franchise city>.ensoport.com |
| Core Node UPS | cups1.<franchise city>.ensoport.com |

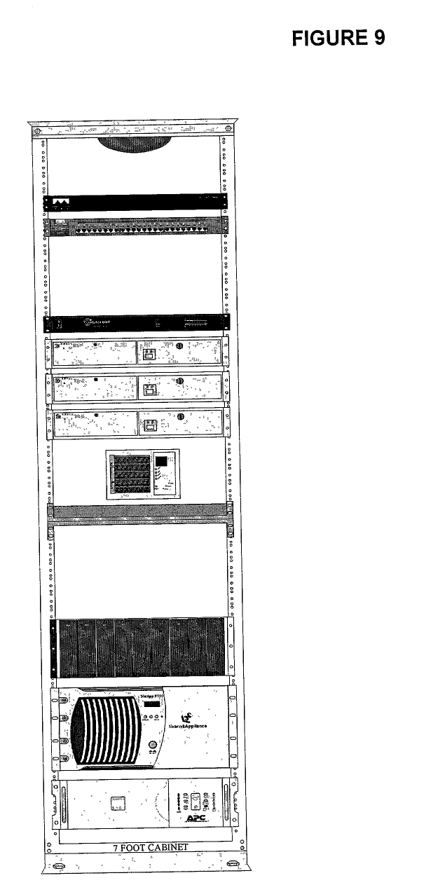

The Core Node rack configuration is depicted in FIG. 9.

Access Node Components

The Access Node is comprised of the following components:

Black Box 40871 Terminal Server (Console Server)

Cisco AS5300 Remote Access Servers (2)

Cisco Catalyst 2924 XL 10/100 Autosensing Fast Ethernet Switch

Cisco CE-505 Cache Engine

APC Smart-UPS 3000 RM 3U T

Access Node component descriptions can be found in Appendix A.

The ensoBox™ is configured with two (2) AS5300s per Access Node, and the following Access Node configurations are standard:

TABLE 8
enso Box™ 1000 Series AS5300 Configuration

| | ensoBox™ T1 | ensoBox™ E1 | ensoBox™ P1 |
|---|---|---|---|
| | Digital 1000 | Digital 1000 | Analog 1000 |
| | Access Node | Access Node | Access Node |
| Number of AS5300s | 2 | 2 | 2 |
| per Node | | | |
| Number and type of | 1-Quad T1/PRI | 1-Quad E1/ | N/A |
| PRI/T1/E1 interface | Card | PRI Card | |
| cards | | | |
| Number of MICA CC | 1 | 1 | N/A |
| Cards | | | |
| Number of 12-port | 8 | 10 | N/A |
| modem modules | | | |

TABLE 9
ensoBox™ 1500 Series AS5300 Configuration

| | ensoBox™ T1 | ensoBox™ E1 | ensoBox™ P1 |
|---|---|---|---|
| | Digital 1500 | Digital 1500 | Analog 1500 |
| | Access Node | Access Node | Access Node |
| Number of AS5300s | 2 | 2 | 2 |
| per Node | | | |
| Number and type of | 1-Octal T1/ | 1-Octal E1/ | N/A |
| PRI/T1/E1 interface | PRI Card | PRI Card | |
| cards | | | |
| Number of MICA CC | 2 | 2 | N/A |
| Cards | | | |
| Number of 12-port | 12 | 15 | N/A |
| modem modules | | | |

TABLE 10
ensoBox ™ 2000 Series AS5300 Configuration

| | ensoBox ™ T1 | ensoBox ™ E1 | ensoBox ™ P1 |
|---|---|---|---|
| | Digital 2000 | Digital 2000 | Analog 2000 |
| | Access Node | Access Node | Access Node |
| Number of AS5300s | 2 | 2 | 2 |
| per Node | | | |
| Number and type of | 1-Octal T1/PRI | 1-Octal E1/PRI | N/A |
| PRI/T1/E1 interface | Card | Card | |
| cards | | | |
| Number of MICA CC | 2 | 2 | N/A |
| Cards | | | |
| Number of 12-port | 16 | 20 | N/A |
| modem modules | | | |

The Access Node P1 Analog 1000 can support 240 analog modems. The Access Node P1 Analog 1500 can support 360 analog modems. The Access Node P1 Analog 2000 can support 480 analog modems.

The AS5300 uses a RADIUS server (in the Core Node) to authenticate remote dial-up sessions. The to RADIUS server, in turn, uses an LDAP server (also located in the Core Node) to grant authorization to ensoBox™ services including web portal, email, web hosting, chat, news, web browsing, etc.

The RADIUS server collects subscriber session accounting records The accounting record consists of the userid, call start, and call finish. From the accounting records, usage for every subscriber is counted each month, and a subsequent bill is produced based on the accounting records that are collected each month.

Cache Engine

The CE-505 supports transparent caching, content filtering, WCCP version 1 and WCCP version 2, HTTP 1.0 and 1.1. It is used to store the most requested objects locally on the ensoBox™, and is accessed by subscribers in a transparent caching mode. When a subscriber requests a URL, the Cisco 2621 router (Core Node) intercepts the request via WCCP version 2.0 and redirects all web requests to the CE-505. The CE-505 checks to see if it has the object(s) that compose the requested HTML. If the CE-505 has the objects stored on its hard drive it then checks the freshness of the objects. If the objects are not expired, it serves the objects back to the subscriber from the CE-505 instead of from the host server that resides somewhere on the Internet. If the CE-505 does not have the objects stored locally, or the object freshness has expired, then the CE-505 retrieves the objects from the host server on the Internet and serves it back to the subscriber. However, the objects are now stored locally to meet future requests for the same objects until their freshness expires.

The CE-505 reduces network latency because URL requests no longer have to traverse the Internet and retrieve the objects from the host server, and it reduces subscriber response time by serving web pages quicker.

Access Node Component Naming Convention

The following table describes the naming convention for the Access Node components.

TABLE 11
Acess Node Component Naming Convention

| Core Node Component | DNS Name |
|---|---|
| Access Node Console | acon1.<franchise city name>. ensoport.com |
| Server | |
| Access Node Switch | asw1.<franchise city>.ensoport.com |
| Remote Access Servers | acserv1.<franchise city>.ensoport.com |
| | acserv2.<franchise city>.ensoport.com |
| Cache Engine | ace1.<franchise city>.ensoport.com |
| Access Node UPS | aups1.<franchise city>.ensoport.com |

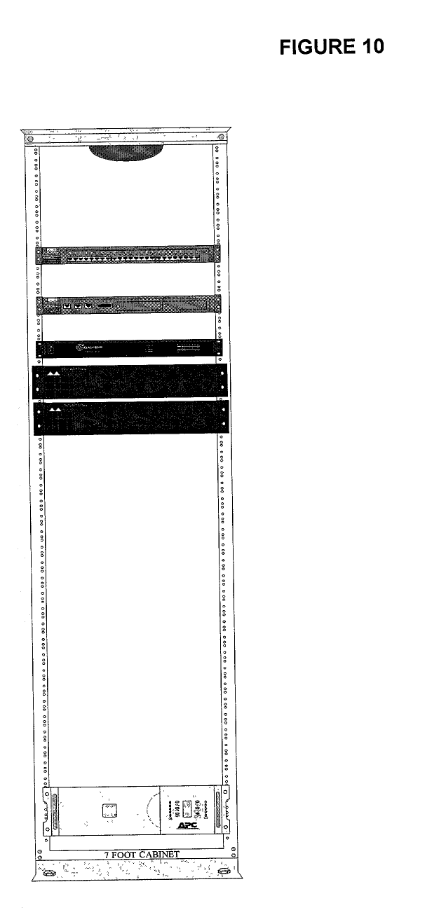

The Access Node configuration is depicted in FIG. 10.

Services Node Components

The Services Node is comprised of the following components:

Black Box 40871 Terminal Server (Console Server)

Cisco Catalyst 2924 XL 10/100 Autosensing Fast Ethernet Switch

Cisco CS-50 Content Smart Switch (Load Balancer)

Tatung Model U10/440 Sun Ultra 10 Compatible SPARC Workstations (6)

APC Smart-UPS 3000 RM 3U T

Services Node component descriptions can be found in Appendix A.

CS-50 Content Smart Switch

The CS-50 is primarily used to balance service requests from subscribers for ensoServices™ residing on six (6) Tatung workstations in the Services Node. Services are installed on a minimum of two (2) servers, and the CS-50 uses the Cisco proprietary Balance ACA load balancing algorithm, which uses the normalized response time from client to server to determine the load on each server, and then routes the request to the server with the least load.

In the event of a failure to one of the servers, the CS-50 will route all future requests for that service to the next available server with the least load.

The CS-50 also uses “sticky” parameters to ensure that subscribers stay connected to one server once an initial session is established. Stickiness is used to ensure that subscribers stay connected to one mail server during their email session. The stickiness is determined by the Session ID assigned to the subscriber at the time a session is initiated. In the event that the mail server fails, the session will be disconnected, and the subscriber will have to initiate another session, which will be established with one of the remaining operational servers.

Services Node Servers

Six (6) Tatung servers are the primary application servers for the ensoBox™. Services such as ensoMail™, ensoWeb™, ensoChat™, ensoNews™, and anonymous FTP run on a minimum of two (2) Tatung servers simultaneously for redundancy. The Cisco CS-50 CSS balances server requests between the six (6) servers based on server load and server availability.

Services Node Component Naming Convention

The following table describes the naming convention for the Services Node components.

TABLE 12
Services Node Component Naming Convention

| Core Node Component | DNS Name |
|---|---|
| Services Node Console | scon1.<franchise city name>. ensoport.com |
| Server | |
| Services Node Switch | ssw1.<franchise city>.ensoport.com |
| Services Node Servers | sfep1.<franchise city>.ensoport.com |
| | sfep2.<franchise city>.ensoport.com |
| | sfep3.<franchise city>.ensoport.com |
| | sfep4.<franchise city>.ensoport.com |
| | sfep5.<franchise city>.ensoport.com |
| | sfep6.<franchise city>.ensoport.com |
| Services Node UPS | sups1.<franchise city>.ensoport.com |

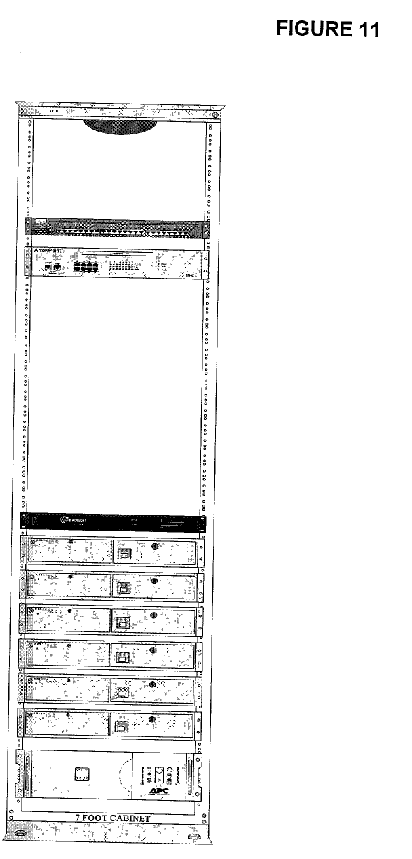

The Services Node is depicted in FIG. 11.

Conclusion

From reading this document you should have:

A general understanding of what an ISP Appliance is and how the ensoBox™ meets the criteria for an ISP Appliance.

An overview of the ensoBox™ including its features and services.

An overview of ensoOS™.

An overview of the design of the ensoBox™.

A technical understanding of the ensoBox™ and its configuration.

An understanding of the components of the ensoBox™.

An understanding of how to the ensoBox™ can be classified as an ISP Appliance.

Keep in mind, the hardware/software vendors and models used in this ISP appliance can and will change from time to time. It is the process and integration that is important. It is the overall functionality that must be maintained.

Appendix A: Hardware Component List

APC Uninterruptible Power Supply

The APC Smart-UPS is a rack mountable unit with an output power of 3,000 VA and 2,250 W, and an input and output voltage of 208 V (North America) or 230 V (Latin America, Asia). It has an input frequency of 50/60 Hz +/−5 Hz (North America) or +/−3 Hz (Latin America, Asia) (auto sensing). It supports an input connection type of NEMA L6-20P (North America) or IEC-320 C20 (Latin America and Asia), and an output connection type of (2) NEMA L6-20R or (1) NEMA L6-30R (North America), or (3) IEC Jumpers or (1) IEC 320 C19 (Latin America and Asia). General features include:

Hot Swap Batteries

Intelligent Battery Management

Overload Indicator

Replace Battery Indicator

SmartSlot Software

Automatic Voltage Regulation (AVR)

User replaceable batteries

The UPS is configured with a DB-9 RS-232 Smart-Slot card to support remote management.

Benchmark DLT7 Autoloader

The Benchmark DLT7 is a seven cartridge 280 GB native capacity (560 GB compressed) tape jukebox with a single drive performance of 3 MB/sec native transfer rate (6 MB/sec compressed), providing enterprise reliability and performance. It's system parameters include:

| | |
|---|---|
| Storage Capacity | 280 GB native, 560 GB compressed |
| Data Transfer Rate | 10.8 GB/hour native, 21.6 GB/hour compressed |
| System Interface | WIDE ULTRA SCSI, Low Voltage Differential |
| | (LVD) |
| Unit Controls | 4 button menu interface keypad |

It can backup over 20 GB of data every hour, and one tape can support one week's worth of data.

The DLT7 is connected to a Tatung workstation, which runs the backup server that conducts scheduled backups of software images and subscriber data.

Black Box 40871 Terminal Server (Console Server)

This Console Server is an AC powered, 8-port, RJ-45, rack mounted unit. It is configured with 1 MB DRAM and 512 KB Flash memory with an 80C186 25 MHz processor. It supports a 10 Mbps Ethernet LAN connection and a 115.2 kbps serial connection. Protocols supported include TCP/IP, Telnet, Riogin, Raw, Reverse Telnet, PPP, SLIP, CSLIP, LPD, RCP, DNS, and WINS. It supports the serial port signals CTS, RTS, DSR, DTR, DCD, RxD, and TxD. Each port can be configured to require password authentication for access.

The Console Server is used to configure and manage the ensoBox™ components. Each node is configured with a Console Server, and each component connects to the Console Server via its RJ-45 console port. To access each component via the Console Server a telnet session is established to the Console Server and its corresponding port (10001 to 10008).

Cisco AS5300 Remote Access Server

The Cisco AS5300 Remote Access Server (RAS) is capable of terminating analog calls and ISDN calls as it is configured in the ensoBox™. It is configured with 128 MB DRAM, 16 MB Packet DRAM, 16 MB Flash, and has a 150 MHz R4700 processor.

It is configured with an auto-sensing RJ-45 10 Base-T/100 Base-TX Fast Ethernet port and an RJ-45 10 Base-T Ethernet port.

Each AS5300 can support up to eight (8) T1s or E1s.

Cisco Catalyst 2924 XL 10/100 Autosensing Fast Ethernet Switch

The Cisco Catalyst 2924 XL contains 24 auto-sensing RJ-45 10 Base-T/100 Base-TX Fast Ethernet ports. For management purposes there is one (1) RJ-45 console port and one (1) RJ-45 auxiliary port.

The Catalyst 2924 is a subscriber of the Catalyst 2900 switch family, which are all auto-sensing Fast Ethernet switches. The switches can be configured to support multiple VLANs, as is the case with the ensoBox™.

Cisco CE-505 Cache Engine

The CE-505 is a cache appliance with a 266 MHz processor, 128 MB SDRAM, 8 MB Flash, 256 KB EPROM, 512 KB L2 cache, a 9-GB Ultra II SCSI LVD disk drive, and two (2) auto-sensing RJ-45 10 Base-T/100 Base-TX Fast Ethernet ports. For management purposes there is one (1) RJ-45 console port and one RJ-45 (1) auxiliary port. The CE-505 is capable of supporting up to 500 concurrent TCP sessions.

Cisco CS-50 Content Smart Switch (Load Balancer)

The Cisco (formerly ArrowPoint) CS-50 Content Smart Switch is an intelligent load balancer that uses specially designed algorithms to balance URL requests amongst a server farm. The CS-50 Content Policy Engine consists of a high-speed superscalar RISC processor, 128 MB of memory, and 5 Gigabits per second (Gbps) of throughput, and delivers per-flow prioritization based on hundreds of user-defined policies. Distributed Flow Forwarding Engines feature per-port programmable network processors for wire-speed delivery of Web content.

The benefits of using the CS-50 include:

Provides high-speed Web content delivery by selecting the best site and server based on full URL, cookie, and resource availability information.

Offers site-level security with wire-speed denial-of-service (DoS) prevention.

Provides eight (8) full-duplex RJ-45 10 Base-T/100 Base-TX Fast Ethernet ports.

Supports all TCP- and UDP-based Web protocols, wire-speed NAT, and integrated IP routing.

Optimizes both content requests and delivery for HTTP, passive FTP, and streaming media protocols.

Cisco 2621 Router

The Cisco 2621 router is an AC powered modular router configured with two (2) auto-sensing RJ-45 10 Base-T/100 Base-TX Fast Ethernet ports, one WIC module that contains two (2) serial WAN ports, each supporting data rates up to 2.048 Mbps, and a 4-port Ethernet Network Module (NM) with four (4) RJ-45 10 Base-T Ethernet ports. For management purposes there is one RJ-45 (1) console port and one RJ-45 (1) auxiliary port. The router is configured with 16 MB Flash memory (1 SIMM), 48 MB DRAM (two 24 MB DIMMs), and the central processor is a Motorola MPC860 50 MHz.

Access Control Lists (ACLs) are configured on the router to control access to various ensoBox™ resources. ACLs control data flow both in to and out of each of the router ports.

Network Appliance F720 File Server (Network Attached Storage)

The F720 File Server provides 126 GB of hard disk space (7×18 GB drives) with 256 MB RAM and an auto-sensing RJ-45 10 Base-T/100 Base-TX Fast Ethernet port. The F720 is a highly available, scalable, and easy to manage network storage solution.

High availability. Built-in RAID protects against data loss from disk failure for reduced downtime, giving users continuous access to data. Clustered failover and redundant components increase reliability, while hot spares deliver maximum data availability. Disk scrubbing ensures data integrity and battery-backed NVRAM provides additional data protection.

Scalable. The F700 series scales from 50 GB to multiple terabytes to grow as capacity needs do. With additional PCI slots, expanding storage and network connectivity is fast and painless.

Easy to manage. An integrated motherboard with onboard 10/100 Base-T Fast Ethernet and a Fast-Wide Differential SCSI adapter allow for easy plug-and-play into the ensoBox™ Additional PCI slots offer easy scalability for storage expansion as well as additional network interface cards such as Gigabit Ethernet and ATM. Redundant, hot-pluggable power supplies and cooling fans make it easy to replace parts and easily retractable system trays decrease repair and service time.

The NAS stores subscribers data as well as software images for the ensoBox™ components. The NAS is a subscriber of two (2) VLANs, the Services VLAN and Core VLAN. Each has a unique network connection to the Core Node Switch #1.

Tatung Model U10/440 Sun Ultra 10 Compatible SPARC Workstation

The Tatung Model U10/440 Sun Ultra 10 Compatible workstation is a 2U rack mountable workstation with a 440 MHz Ultra SPARC IIi processor and 512 MB RAM and two (2) internal 9 GB hard drives (HDD) with Ultra Wide SCSI interfaces, for a total of 18 GB of disk storage. It has a primary cache of 16 KB (data) and 16 KB (instruction), and a 2 MB external cache. Its network port is an RJ-45 10/100 Mbps Fast Ethernet port.

The Tatung U10/440 also has two (2) RS-2323C/RS-423 serial ports and one (1) DB-25 parallel port.

We claim:

1. The invention of an ISP appliance that will enable Internet Service Providers to get their business started without concern for technology.

2. With respect to claim 1, the ISP appliance is the first ever complete and total solution like this for deploying all Internet services that an ISP will sell to it's customer base.

3. The creation of a concept labeled nodularity, such that each technical business function of an Internet Service Providership can be contained within a node and each such node can be expanded.

4. With respect to claim 3, currently the invention of a core, services and access node that enables Internet Service Providers to become operational more quickly than ever before.
